(19) United States
(12) Patent Application Publication
(10) Pub. No.: US 2005/0085293 A1
(43) Pub. Date: Apr. 21, 2005

(54) Method and system for supplying funds to a terminal for remote wagering

(75) Inventor: Herbert Lindo, Mineola, NY (US)

Correspondence Address: Gordon D. Coplein Esq., 1046 Oakpointe Place, Dunwoody, GA, 30338, US

(73) Assignee: Kenilworth Systems Corporation.

(21) Appl. No.: 10/960,147

(22) Filed: Oct. 7, 2004

Related U.S. Application Data
(63) Continuation-in-part of application No. 10/941,541, filed on Sep. 15, 2004.
(60) Provisional application No. 60/511,587, filed on Oct. 15, 2003.

(51) Int. Cl. G06F 19/00; G06F 17/00

(52) U.S. Cl. 463/25

(57) ABSTRACT

A method and system of enabling wagering by a player from a location remote from where a game is being played in which a player at the remote location upon being cleared to be able to place wagers in a jurisdiction obtains a set top box or dedicated terminal by which the games can be viewed, game status data received and an account of the wagering results and running balance is maintained. The player also obtains one or more play cards that are unique to the set top box at the remote location. Authorized stations are established at which transactions can take place and a player visits an authorized station to conduct a deposit or withdrawal transaction from an account associated with a play card, and the authorized location communicates with the set top box to update the account at the remote location with the transaction data. The set top box can have a reader to accept a personal identification card for the player which can be a credit or debit card that also can be used to effect commercial transactions.

### PRIORITY CLAIM

This application claims the benefit of priority under 35 U.S.C. § 119 (e) from U.S. Provisional application Ser. No. 60/511,587, filed Oct. 15, 2003, entitled “METHOD AND SYSTEM FOR SUPPLYING FUNDS TO A TERMINAL FOR REMOTE WAGERING”, the disclosure of which is incorporated by reference as if set forth fully herein.

### RELATED APPLICATION

This application is a continuation-in-part of U.S. application Ser. No. 10/941,541 filed Sep. 15, 2004.

### FIELD OF THE INVENTION

The invention relates to a method and system for supplying funds to be used at a terminal for remote wagering.

### BACKGROUND OF THE INVENTION

In U.S. Pat. No. 6,575,834 of Herbert Lindo, owned by Kenilworth Systems Corporation, the disclosure of which is incorporated in its entirety herein by reference, a method and system is disclosed and claimed for placing wagers on a casino table type game, such as roulette, card games such as poker, blackjack or baccarat, or dice, at a site remote from the actual casino table at which the game is taking place. In the method and system of that patent there is a camera at the casino that follows a game that is being played at a table. A microphone is usually provided that can pick up the sound of the players at the table and the game play as well as the crowd near the table. Terminals are provided at various locations remote from the table to receive a video display of the game play and, if desired, the sounds of the table game play and casino crowd. The remote terminals also receive game result data and game betting status signals from the casino game via a conventional communication distribution device that can be closed circuit, wireless satellite, analog or digital cable, or the Internet.

Each remote terminal also contains its own computer, hereafter referred to as a microprocessor, that performs various functions which include the generation and display of an electronic representation or live picture presentation of the betting grid of the table game being played. The remote terminal microprocessor also stores a table of the betting odds of the game being played on which wagers are to be placed. The player at a remote terminal uses the displayed betting grid in combination with a touch type keypad, touch type screen, mouse, personal digital assistant (PDA) or similar device to electronically place a wager.

The remote terminal microprocessor receives the game result data and uses the stored information of the game odds to calculate and pay off a winning amount when the player has placed a winning wager. The remote terminal microprocessor also maintains a running status of the player's account by adding calculated winnings and subtracting losing wager amounts. Money can be deposited to the account of the player at a remote terminal by a credit or debit card in a transaction transmitted to the terminal from a central location, such as a credit card company, or by wire transfers from a bank or other financial institution. Money can also be deposited at the terminal in cash via a bill acceptor on a direct basis.

While a terminal can have its own dedicated display screen, an equivalent configuration can be made by using a conventional television monitor with a special “set top” box, patterned after those used with expanded service pay television cable or satellite service. The conventional television set top box would be modified to additionally contain the computer or microprocessor device used for placing wagers by generating and displaying a betting grid. It also would have the necessary connection for, or a self-contained, key pad or cursor movement device, or other suitable device to place a bet on the displayed betting grid. The microprocessor in the set top box also would be capable of computing winning amounts based on game result data received from the casino and the stored odds table and maintaining the running account of the player. Deposits to the player's account also can be made via the set top box in the manner previously described.

A sociological problem can arise when a dedicated terminal or set top box is used for wagering at remote locations, such as the home. For example, under aged persons and compulsive gamblers possibly place wagers. Therefore, it is desirable to provide a method and system for preventing such vulnerable people from establishing an account to place wagers or restricting access to and/or the size of the monetary account from which wagering can be conducted.

### BRIEF DESCRIPTIONS OF THE INVENTION

The present invention provides a method and system by which access to placing wagers on a game from a remote location can be controlled. While the preferred embodiment of the inventions is described using a hardware configuration of a television set and a Set Top Box, it also applies to situations in which a dedicated terminal is used. Both configurations are hereafter referred to as a Set Top Box.

The method and system of the invention is to be used to control wagering at locations remote from the place where a game is being played and is made specific to a particular jurisdiction so that there will be compliance with the laws of that jurisdiction regarding wagering. One such type of jurisdiction is that which is established to conduct a lottery and can be a city, county, State-wide, entire or part of a national country, or any combination of one or more of these. All of such jurisdictions have authorized locations that sells lottery tickets as officially permitted by the Governmental body of the jurisdiction. Such authorized locations are hereafter referred to as Lottery Stations and can be a dedicated location, in a store or other facility, etc. The lottery systems of such jurisdictions also usually include a central database and a network that provides communication with the authorized locations. The authorized locations typically have one or more terminals for issuing lottery tickets that are in communication with the central database. Tickets are sold from the terminals at the authorized locations and pay-offs of winning tickets are made after verification of a winning number with the central database. Many of such authorized locations employ authorized agents who are licensed by the Government authority of the jurisdiction.

In implementing the invention, a person desiring to place wagers on casino type games purchases, leases or is given for free a Set Top Box or dedicated terminal to be used for placing wagers. The manner by which the Set Top Box is obtained depends on the jurisdiction and various commercial factors. The Set Top box is to be connected to a communication system to receive on a free basis, or as part of a conventional subscription package, or a special subscription, to a service that broadcasts games, such as from a casino, on which wagers are to be placed. At the time of obtaining the Set Top Box the person, hereafter called “player”, who wants to wager on the broadcast casino games, presents suitable personal identification to verify that he is permitted to make wagers in the jurisdiction of the lottery system with which he is to be associated to use the authorized locations of the jurisdiction. Verification can include checking the documentation presented to make sure that the person satisfies the laws of the jurisdiction for placing wagers on games played at casinos. For example, the lotteries of various States and countries have established minimum age limits (18-21) and the verification process enforces these limits under criminal penalty of state or jurisdiction*s laws. The regulations governing buying lottery tickets, or special regulations, are adopted for Set Top Box wagering. Therefore, under aged people are prevented from establishing and using Set Top Box wagering accounts. Also, as explained below, the compulsive gambler can be limited in their gambling habits.

At the time of obtaining the Set Top Box, or soon thereafter, the player is issued one or more Play Cards. Each of the Play Cards initially issued, or those issued at a later time, is unique both to the player who is to use the Set Top Box and the Set Top Box itself. The Play Card issued to the player is encoded with various data items. These include a unique number, preferably a personal identification (PID) number for the player, identification numbers assigned to the television set and Set Top Box (or dedicated terminal), the satellite or cable subscribers account number used at the Set Top Box location, and the satellite provider's identification number that regulates the Set Top Box programming. Some of this information is known to the agency selling or leasing the Set Top Box and the balance provided by the player.

The encoding on the Play Card is accomplished by any suitable conventional technique, such as imprinting using encrypted bar code technology, magnetic coding, optical writing or implanted integrated circuit technology on a compatible medium. A Play Card also has spaces on which currency, e.g., dollar, amounts can be written or boxes checked for such currency amounts. In a preferred embodiment of the invention, a plurality of the Play Cards are issued at the same time, such as in booklet form, and the cards preferably are sequentially numbered. The Play cards can be replenished on a scheduled basis or upon request by the player. The Play Cards also can be sold by banks, credit card companies or other financial institutions. It is also preferred that the player be issued an encoded Identification card with the initial supply of the Play Cards.

The person who obtains a Set Top Box or dedicated terminal also establishes an account to be used for wagering. The account data is stored in the jurisdiction central database. Deposit and withdrawal transactions for the account are carried out at the authorized locations in the jurisdiction using the Play Cards. The invention is also applicable to other controlled situations such as a hotels, resorts, restaurants, public gathering places and casinos. Such authorized locations are all also hereafter called Lottery Stations.

The authorized locations, e.g. Lottery Stations, and their personnel are used to effect deposit and withdrawal transactions for a players account. To do this, the player brings a Play Card to a Lottery Station. If desired, the Lottery Station can request identification verification that the person presenting the Play Card is the proper owner of the Play Card. The player has marked or marks on the Play Card an amount and type of transaction, that is, a deposit or withdrawal to be credited or debited to the account associated with the Set Top Box with which the Play card is associated. The Lottery Station includes at least one terminal used to issue lottery tickets that is connected to the communication network of the jurisdiction that controls the lottery. The Lottery Station conventional lottery terminal is implemented to accept a Play Card, or a dedicated special terminal for the Play Cards is provided at the Station.

At the Lottery Station the agent activates the authenticated and approved Play Card by placing it in the appropriate terminal and keying in the amount of the deposit or withdrawal. The Lottery Station transmits the transaction data to the player's Set Top Box. This is done by any conventional communication system, such as over a telephone access line, via cell phone, television satellite or cable system, Internet, etc. The Set Top Box is configured for placing casino game wagers and to maintain a running account in the manner described in the aforesaid patent. The Set Top Box microprocessor also is configured to receive and accept deposit and withdrawal data made via a Play Card transaction. The data of the type of the transaction (deposit or withdrawal) and the amount made at and transmitted from the Lottery Station is stored in the Set Top Box microprocessor memory and the account balance is updated, as described in the aforesaid patent. The transaction data also is transmitted to the central database.

The player returns to the location at which the Set Top Box is located. If the account maintained by the microprocessor at the Set top Box has a positive balance, the player can place wagers and the microprocessor in the Set Top Box maintains a running account balance as described in the aforesaid patent.

When the player desires to cash out or withdraw a part of the funds from his account, he takes a Play Card to a Lottery Station. The amount to be withdrawn from the account is designated on the Play Card. The Lottery Station agent inserts the Play Card into a terminal that checks its authenticity and communicates with the Set Top Box and obtains the running balance maintained in the Set Top Box microprocessor. If the running balance is adequate to pay the requested amount, the agent at the Lottery Station pays out this amount. Data of the amount paid out is transmitted back to the Set Top Box microprocessor and the stored running account balance is updated.

All Lottery Station transactions are recorded, preferably both at the Lottery Station making a transaction and also at a central location, such as a computer database of the jurisdiction. Wagering and transaction data also can be stored in the Set Top Box microprocessor and made available for review from a Lottery Station or the lottery central database.

In the television Set Top Box configuration, satellite and digital cable subscribers can be provided with programming in which they will be able to watch live in progress casino table games (roulette, craps, baccarat, and more) together with entertainment and commentary, much like commentators provide at sporting events, to assist players with the rules and strategies of the games. Also, using the technology disclosed in the aforesaid patent a subscriber using his television set can place wagers using the microprocessor located inside the Set Top Box. All of the wagering management and action takes place within only several feet of where the player sits to watch the games and place wagers.

In a further implementation of the invention the Set Top Box can be provided with a reader such as of the magnetic card or other conventional type. The reader is to be used in conjunction with a card issued to the player which can be either a personal identification card dedicated to the wagering system or the player' conventional credit or debit card. Both of these types of cards can be used to enable wagering from the location. That is, the player must first insert the card in the reader, such as by “swiping” if the card is of the magnetic stripe type, to establish his identity before the Set Top Box will be enabled to accept wagers. Where the card is of the conventional credit or debit card type, the Set Top Box can be configured to communicate to conduct commercial transactions such as paying for goods ordered over the telephone or the Internet.

### BRIEF DESCRIPTION OF THE DRAWINGS

Other objects and advantages of the invention will become more apparent upon reference to the following specification and annexed drawing in which:

FIG. 1 is a schematic diagram of the communication setup used with the invention;

FIG. 2 is a flow chart showing the flow of the steps; and

FIG. 3 is a schematic flow chart of a further embodiment.

### DETAILED DESCRIPTION OF THE INVENTION

The following description is to be taken in conjunction with the general description of the Invention presented above.

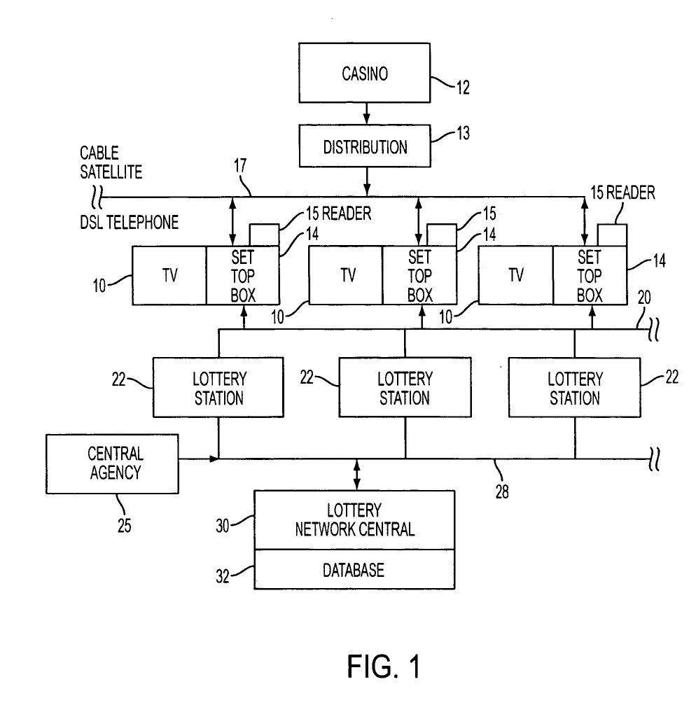

Referring to FIG. 1, there is shown a plurality of television sets 10 each one being at a remote location relative to a casino 12 where the game on which wagers are made takes place. The invention is applicable to most types of games played in a casino, such as roulette, dice, blackjack, baccarat and others. The casino 12 transmits the game play and the game results via a suitable conventional communication distribution system 13, that interfaces with a conventional transmission-communication medium 17 such as a cable system, satellite, over the air, DSL telephone line, Internet or other available medium. The casino communication system 13 is capable of transmitting the video of the game being played, game result winning data, and betting status signals of start and termination of wagering as described in the aforesaid patent.

Each television set 10 has a Set Top Box 14 connected to it that is configured to be capable of receiving the casino game play and the betting data and game status data transmitted from the casino 12. The Set Top Box is to be used for one or more jurisdictions in which a player has been approved to make wagers. Acquisition of the Set Top Boxes 14 can be by purchase, lease, free use, or any combination of these. As described below, distribution of the Set Top Boxes is controlled by a central agency.

The Set Top Box 14 is appropriate to the type of communication medium or system 17 with which it is used to receive the games broadcast from the casino. The casino does not have to be in the jurisdiction to which the Set top Box applies. The Set Top Box preferably has a reader 15 to accept an identification card unique to the player and/or to read a conventional debit or credit card. It preferably also has the usual components to receive conventional television entertainment programs. When the communication medium 17 is a cable system the conventional entertainment programs are received over the cable and this is also possible using the Internet or satellite as the communication medium. Use of cable or satellite by the player also permits establishment of an Internet connection so that the player can conduct various commercial transactions, such as shopping. and to transmit data, such as credit card billing information, from the Set Top Box reader 15. That is, the player would make a purchase from an establishment such as a department store and pay for it by swiping his credit or debit card through the Set Top Box reader 15. The credit/debit card data received from the reader 15 is used in the usual manner by the establishment making the transaction for billing and other puposes. If the players location does not have cable or satellite, then the Set Top Box 14 can be configured to transmit data, such as from a credit/debit card, from the reader 15 over a conventional telephone line.

The Set Top Box 14 also contains the components necessary to generate the betting grid on the television set display screen, to place wagers on the game being played, to compute the win-loss amounts based on a table of stored odds and to manage the balance in the player's account all in the manner described in the aforesaid patent.

Each Set Top Box 14 also has communication over a network 20 with authorized locations, here shown as a plurality of Lottery Stations 22, in the jurisdiction in which the wagering is taking place. As described, there is no communication from the Set Top box to the Lottery Station or central database 32 but this can be provided if desired. This can be by a telephone line, cable or over the Internet. By using the network 20 a Lottery Station 22 can access all of the Set Top Boxes 14 to transmit data to and obtain data from them. Other facilities, for example, Governmental offices, banks, etc., can be used as authorized locations or there can be specially designated authorized locations in addition to the Lottery Stations 22. All such facilities are to be considered as being within the term Lottery Station used in describing the invention.

There also is communication over a network 28 between the authorized location Lottery Stations 22 and a central location 30, such as the central or master lottery control for the jurisdiction. The central location 30 also has a database 32 that already stores data provided from the individual Lottery Stations, such as tickets sold, the numbers selected on each ticket, winning ticket numbers, redeemed tickets and other information. The two communication networks 20 and 28 are preferably integrated as a single network so that there can be direct communication between the central location 30 and its database 32 to any Set Top Box 14.

As described below, a central agency 25 controls issuance and distribution of the Set Top Boxes and issuance of the Play Cards which permits a player to place wagers. The central agency 25 can be linked to the communication network 20 to provide the central database 32 with information concerning the Set Top Box and the player.

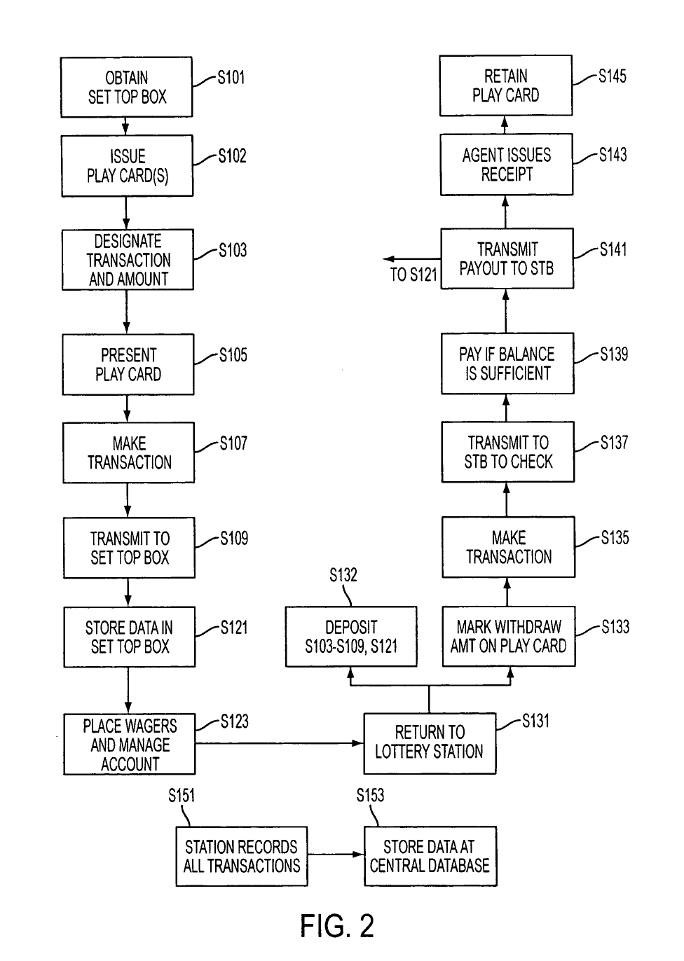

FIG. 2, shows the various steps carried out in using the invention.

S101. A player purchases, leases or is given for free, or any combination of these, a Set Top Box 14 to be used to place wagers in a jurisdiction. Distribution of the Set Top Boxes preferably is controlled by the central agency 25 which can be a special entity authorized or established by the jurisdiction. The central agency 25 can appoint sub-agents to effect or assist in the actual purchase, lease, or other type of issuance transaction and to acquire the information from the potential player that is necessary to establish his legal ability to be able to place wager in the jurisdiction. Sub-agents can be specially established or designated locations and can even be the Lottery Stations. When a person seeks to acquire a Set Top Box he provides to the central agency directly or through a sub-agent the personal information required by the jurisdiction to show that he can legally place wagers in the jurisdiction. This can be documentation establishing identity and age. A check can be made of the personal data to make certain that the player can legally place wagers on casino games in the jurisdiction. For example, the player may recently have been placed on a list of people prohibited from wagering. Such information would be stored and made available from the central database 32. If the person seeking to acquire the Set Top Box is not authorized to place wagers in the jurisdiction, for example, being underage, the Set Top Box will not be sold or leased and Play Cards will not be issued. The check can be made by the sub-agent if it has access to this data or can be made by the central agency 25.

The player also provides information of his television set and communication system protocol to be used to communicate with the Set Top Box. The player also would provide similar information if his playing location has a dedicated terminal. The central agency 25 has the identification data for the Set Top Box to be issued to the player.

All of the player personal information and technical information pertinent to the Set Top Box and communication protocol is recorded and stored. The necessary part of this information is transmitted to the central database 32 and an account established that is unique to the Set Top Box and the player.

S102. One or more Play Cards are issued after the player's identification and ability to place wagers in the jurisdiction is cleared. The Play Cards preferably are issued only by the authorized agency 25 for security reasons.

Each Play Card is encoded with its own unique ID number and also is specific to at least the, Set Top Box obtained in S101. This data is placed on a Play Card by any conventional process such as printing, optically encoded, magnetically encoded, integrated circuit chip, etc. Preferably, a plurality of the Play Cards are issued at the same time and can be bound into booklets similar to bank checks for easy handling and protective storage. When a plurality of Play Cards are issued they preferably are sequentially numbered. Each Play Card preferably also has printed spaces for designating various transaction types, such as deposit, withdrawal or close account, and the amount of the transaction, requiring the player only to mark the desired transaction type and amount. After the initial supply of Play cards is effected, the player's supply can be replenished on an automatic basis or upon request.

At the time of the initial issuance of the Play Cards the player can be issued a personal identification card to be used with the Set Top Box reader 15 to ensure that only he can make wagers from the location. The player's credit or debit card also can be used for the same purpose. That is, the Set Top Box will not be enabled to accept wagers until the player has inserted a card in the Set Top Box reader 15 that correctly identifies the player.

S103. The player uses a Play Card by designating on the card an amount and type (deposit or withdrawal) of a transaction.

S105. The player presents the marked Play Card to an agent at a Lottery Station. The agent can request further identification if desired. Since the card is unique to a particular Set Top Box the problem of an improper person presenting the card is minimized.

S107. The Lottery Station agent inserts the Play Card into a terminal at the Lottery Station which is equipped to optically, or by any other suitable technique, recognize the marked transaction type (deposit or withdrawal) and amount. If desired, the agent can key the data into the terminal. The first Play Card used by a player should be a deposit into the player's account. If a deposit to the players account is to be made, both initially and at a later time, the player also gives the Lottery Station agent cash funds, a check, debit card or information of the player's credit card account.

S109. The Lottery Station transmits the type and amount of the transaction to the Set Top Box microprocessor over the network 28. Since the presented Play Card is unique to only one Set Top Box, there will be communication by the Lottery Station with only that Set Top Box. As should be apparent, a player possibly could connect his Set Top Box 14 to different television sets 10. The overall system can be configured to either permit or prohibit this. Also, the data of the transaction conducted at the Lottery Station is transmitted to the central database 32 and is stored.

S121. The Set Top Box receives over the network 20 the transaction type and amount transmitted from the Lottery Station and this data is stored in the memory associated with the microprocessor which manages the player's wagering account. The running account balance stored in the Set Top Box microprocessor is updated. The player can now place wagers.

S123. The player returns to the location where the Set top Box is located and views the casino table game action on the television set 10. As an added security step to avoid having an unauthorized person place a wager, the player inserts his encoded personal identification card or his credit/debit card in the Set Top Box reader 15. This is not entirely necessary but is desirable to prevent others at the location, such as children, from making wagers. Also, as indicated above, the player can transmit credit/debit card data from the reader 15 to make a commercial transaction. The player views the electronically generated betting grid on the television set 10 and places wagers in the manner described in the aforesaid patent. The Set Top Box also receives game status data from the casino, such as the start of the game, close of betting and winning number. This is preferably accomplished on a real time basis although the game proceedings can be done by tape or digital delay.

The Set Top Box microprocessor keeps a running account of the wagering by computing a winning wager amount and adding it to the account balance and subtracting wager losses. The Set Top Box circuitry preferably is configured to make the television screen constantly display the account balance available during and after each wager.

S131. To cash out (withdraw funds) or to place more money in the account, the player returns to a Lottery Station. The Player uses the next higher numbered Play Card from his booklet of cards to make a transaction and it is presented to the Lottery Station agent.

S132. To make a deposit to replenish or increase the balance in the player's account, the procedure is carried out in the manner set forth in steps S105-S109 and S121.

S133. In making a withdrawal, the player can request the full amount or a partial amount from his account. The Player marks the amount of the withdrawal on the Play Card and presents it to the agent.

S135. The Lottery Station agent inserts the withdrawal transaction Play Card into the Lottery Station terminal which optically, or by any other suitable technique, recognizes the transaction type and withdrawal amount. The Lottery Station agent can key this information into the Lottery Station terminal. If desired, the Lottery Station agent can request personal identification when a withdrawal is requested.

S137. The terminal at the Lottery Station communicates with the Set Top Box and verifies the balance available in the account as computed by the Set Top Box. A cross-check can be made with the central database if desired.

S139. If the amount of the running balance stored in the remote terminal Set Top Box microprocessor equals or exceeds the amount requested to be withdrawn, the Lottery Station agent pays.

S141. The amount paid is transmitted to the Set Top Box over the network 20 and is deducted from the balance stored in the microprocessor in the Set Top Box.

S143. The Lottery Terminal issues the player a receipt for the amount paid and deducted from the account in the Set Top Box. The receipt also can list the amount remaining in the balance at the Set Top Box microprocessor.

S145. The Lottery Station agent preferably keeps the Play Card on which the withdrawal is based. The Play Card used for withdrawal can be stored in a central location or destroyed.

S151. The terminal at the Lottery Station automatically records all transactions performed in the player's account. This includes the unique number of each Play Card used, whether a deposit or withdrawal transaction and its amount and the date and time of the transaction.

S153. It is preferred that data of all of the transactions at all Lottery Stations be sent to the central station 30 and its database 32. This keeps a record of all transactions carried out that relate to each Set Top Box and the player and his account and makes available to the Lottery system and/or the player a historical listing of his account. This also permits the system to be integrated with the jurisdiction's lottery accounting system to establish disbursements of funds pursuant to agreements with the Lottery Locations of the jurisdiction. The centrally stored data also can be used by the tax authority of a jurisdiction to determine if the player has paid taxes on winnings if this is the law of the jurisdiction.

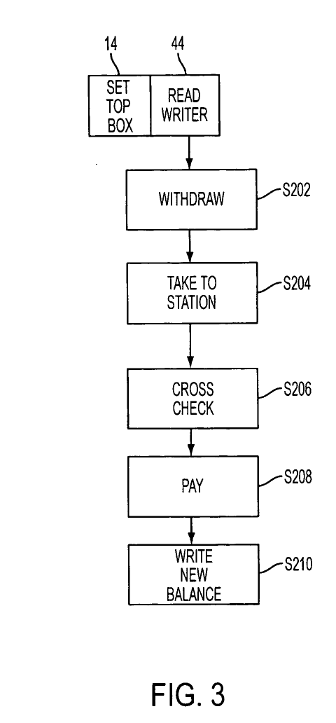

In a further embodiment of the invention as shown in FIG. 3, the Set Top Box 14 has a reader/writer 44 compatible with the data encoding technique used for the Play Card. The Set Top Box and Play Cards used here are issued in the manner set forth in S101, S102, S103, S105 and S107 and the financial data transmitted to and stored in the Set Top Box as in S121 and S123. In this embodiment, the communication networks of FIG. 1 also are present and it is preferred that the central database 32 record all transactions.

Here, a Master Play Card is used that is of the type, such as a magnetic stripe, on which data can be written by a Lottery Station terminal. The Master Play card can be used either in addition to or in place of the personal identification card used with the Set top Box reader 15. This master Play Card is inserted in a reader/writer 44 present in the Set Top Box 14 which recognizes the encoded identification data and financial transaction data. By recording the deposit amount on the Master Play Card the account balance transmitted to the Set Top Box microprocessor by the Lottery Station is cross-checked. The Master Play Card is used in the Set Top Box reader/writer 44 preferably at the beginning and end of each wagering session so that the account balance is read from the card at the start of the session and the new balance recorded on the card at the end of the wagering session. It is preferred that the Set Box microprocessor also keeps a running balance of the account.

The reader 44 also can be used in the same manner as the reader 15 of FIG. 1 to make a commercial transaction such as by a credit or debit card. The Master Play Card also could be encoded for this purpose.

To make a withdrawal from the account, in S202 the player takes the Master Play Card used with the Set Top Box reader/writer 44 and in S204 presents the card to the agent at the Lottery Station. In S206 the agent places the card in a reader to determine the account balance and there can be a verification of the balance against what is stored in the Set Top Box microprocessor. If the account associated with the Master Play Card has a positive running balance amount, then this amount is paid to the player in S208. If the player wishes to continue playing, a new balance is written in the Master Play Card in S210 and the account balance stored in the Set Top Box microprocessor is updated. The player takes the updated Master Play Card back to the Set Top Box and continues play.

If the system of FIG. 3 is used without a cross-check back to an account balance stored in a Set Top Box microprocessor, then the player can play at different terminals. A Master Play Card can be encoded at the time of its issue to write data into the Set Top Bos microprocessor, for example, personal identification data and data to prevent wagers above a certain limit from being accepted.

Such a system as in FIG. 3 can be used in a premises such as a hotel or resort where the player would purchase a Play Card at the hotel premises and the Set Top Box is associated with the television set in the player's room. The player would wager from his room and cash in his wagering account balance, which could be integrated with his room account, at the premises.

The method and system of the invention has a number of advantages in controlling wagering. For example, under aged persons will be unable to obtain Play Cards for wagering.

If the under aged resides in households that have a television with a Set Top Box and the under aged manages to secure the Play Cards, frequent use of the consecutive numbered Play Cards, placement of more or larger than normal wagers can trigger an alert that an unauthorized person has wagered on the system. As a further measure to prevent unauthorized use, the Set Top Box microprocessor may be programmed with a personal identification number (PIN) so that it will not accept wagers unless the correct PIN has been entered.

The Set top Box microprocessor also can be programmed to operate only between designated hours, for instance only when adults are present, such as after 8:00 p.m. etc.

The vulnerable and the compulsive gambler can be identified by their wagering habits. Jurisdictional laws can be set to limit the maximum amount that may be deposited in a wagering account at one time, or within a given time period. Also, a maximum amount account value can be programmed into the Set Top Box microprocessor directly or by a Lottery Station as well as a maximum amount for each wager. When the vulnerable and the compulsive gambler exhausts their account balance, they must stop wagering, and return to a Lottery Station to make a new deposit. This feature gives any player an opportunity to rethink his compulsive action.

As explained above, the method and system of the invention records all deposit and withdrawal transactions and the time and date. Using arrangements with the jurisdiction lottery a guideline may be established to prevent impulsive wagering on the system by setting limits on how much may be deposited during any period of time and days. If violated, the wagering at the microprocessor can be shut off or interrupted by commands from a Lottery Station 22 or the central station 30 to keep the limits within the established guidelines. A number of methods are available that can identify the players that do hard-core gambling instead of using the system for its intended entertainment design.

The method and system of the invention of controlling wagering using television broadcasting tracks and records all transactions at all times and can be configured to regulate the amount that can be wagered during any interval (hourly, daily, weekly, or monthly) by the players.

In an alternative implementation of the invention, the Play Cards are originally issued without payment and payment made at the time of presentation of a Play Card to an agent at a Lottery Station. Here, a player would establish a source of funds, such as a bank account or credit card account, to service his wagering account and the amount needed would be taken from this source.

While the invention has been described with respect to Lottery Stations that issue lottery tickets, it can be implemented at other premises that are authorized to place wagers, such as an off-track betting locations, “bookies” authorized to take bets (such as in the United Kingdom), etc. Further, other locations can be authorized for wagering, such as a hotel or chain of hotels, a resort, etc. All such other premises would be considered a Lottery Station within the foregoing description.

The invention has decided advantages relative to a jurisdiction that is trying to increase revenue income. States and other jurisdictions that conduct lotteries will wish to participate for this purpose. For example, twenty-three states in the United States have passed gambling legislation as of November 2002 with all lottery proceeds earmarked for education and/or social assistance projects.

Specific features of the invention are shown in one or more of the drawings for convenience only, as each feature may be combined with other features in accordance with the invention. Alternative embodiments will be recognized by those skilled in the art and are intended to be included within the scope of the claims.

1. A method of enabling wagering by a player from a location remote from a place where a game is being played, such remote location having apparatus to view the game being played and to receive betting status signals and results of the game outcome, place wagers on the game and maintain an account of the wagering results, comprising the steps of:
a player obtaining a play card that is unique to the apparatus at the remote location from which a wager is to be placed and the wagering account associated with the apparatus;
establishing authorized stations at which transactions for the account can take place;
a player presenting a play card at an authorized station to effect a transaction of one of making a deposit to or withdrawal from the account associated with the play card;
the authorized location making the transaction; and
updating the account of the remote location apparatus with the transaction.

2. The method as claimed in claim 1 wherein for a withdrawal transaction the authorized station first checks the account maintained by the remote location apparatus to determine if funds are available before paying the withdrawal amount.

3. The method as claimed in claim 1 further comprising the step of the player presenting identity information to be used to verify that the player can place wagers in a jurisdiction associated with the remote location apparatus.

4. The method as claimed in claim 1 further comprising the step of the player presenting information to be used to verify that the player can place wagers in a jurisdiction associated with the remote location apparatus before the player can obtain said apparatus.

5. The method as claimed in claim 1 further comprising the step of the player presenting information to be used to verify that the player can place wagers in a jurisdiction associated with the remote location apparatus before the player can obtain play cards.

6. The method as claimed in claim 1 wherein the play card contains information unique to the apparatus at the remote location that maintains the account at such remote location.

7. The method as claimed in claim 1 further comprising the step of an authorized station maintaining a record of transactions made by a player.

8. The method as claimed in claim 1 further comprising the steps of:
maintaining a database at a central location that is in communication with all of said authorized stations; and
recording in said central location database transactions made by players at authorized stations.

9. The method as claimed in claim 7 further comprising the steps of:
maintaining a database at a central location that is in communication with all of said authorized stations; and
recording in said database transactions made by players at authorized stations.

10. The method as claimed in claim 8 wherein in the step of conducting a transaction that is a withdrawal the account balance maintained by the apparatus at the remote location is checked.

11. The method as claimed in claim 8 wherein in the step of conducting a transaction that is a withdrawal the account balance maintained by the central database is checked.

12. The method as claimed in claim 8 wherein in the step of conducting a transaction that is a withdrawal the account balance maintained by both the apparatus at the remote location and the central database are checked.

13. The method as claimed in claim 1 wherein the step of issuing a play card comprises issuing a plurality of said cards at the same time.

14. The method as claimed in claim 13 wherein said plurality of cards are numbered in sequence.

15. The method as claimed in claim 1 wherein in the step of conducting a transaction of making a deposit such deposit can be made by any one of using cash or by electronic transfer.

16. The method as claimed in claim 1 further comprising the steps of:
issuing an identity card unique to the player; and
the apparatus at the remote location accepting wagers only if said identity card is recognized by the apparatus.

17. The method as claimed in claim 8 wherein the apparatus at the remote location includes a device for reading from and writing to a media data of the account maintained by the apparatus and the step of conducting a transaction further comprises:
writing on the media the balance of the account maintained at the remote location;
presenting the media at an authorized station; and
cross-checking the balance on the card against the account balance in the central database.

18. The method as claimed in claim 1 wherein the apparatus at the remote location further comprises a reader of a credit or debit charge card having identification data and further comprising the steps of:
conducting a transaction by using the credit or debit card in said reader; and
transmitting the data of the card as read from the reader from the remote location to a location associated with the transaction.

19. A system for enabling wagering by a player from a location remote from where a game is being played, comprising:
apparatus at the remote location and place where game is being played to provide communication to view the game and to receive betting status signals and results of the game outcome, place wagers on the game and maintain an account of the wagering results;
a plurality of authorized stations at which a player can obtain a play card that is unique to the remote location from which wagering is to take place and deposit and withdrawal transactions made; and
a communication network linking said authorized stations and said apparatus at said remote locations;
wherein said apparatus at the remote location operates to updates the account at the remote location with the transaction made at the authorized location.

20. The system as claimed in claim 19 wherein the play card issued at a said authorized station contains information unique to the apparatus at the remote location that maintains the account at such remote location.

21. The system as claimed in claim 21 further comprising:
a database at a central location; and
a communication network linking said central location and all of said authorized stations;
wherein said database records transactions made by players at authorized stations.

22. The system as claimed in claim 21 wherein said communication network links all of said central location and its database, said authorized stations and said remote locations.

23. The system as claimed in claim 19 wherein the apparatus at the remote location further comprises a reader of a credit or debit charge card having identification data by which a transaction can be conducted by using the credit or debit card in said reader; and
means for transmitting the data of the card as read from the reader from the remote location to a location associated with the transaction.

24. The system as claimed in claim 23 wherein at least a portion of said apparatus is incorporated in a set top box to be used with a television receiver at the remote location.

25. The combination comprising:
a television receiver;
a set top box associated with said television receiver to receive and provide selection of programs to be displayed on said television receiver;
a reader of a credit or debit charge card having identification data by which a commercial transaction can be conducted by using the credit or debit card in said reader; and
means for transmitting the data of the card as read from said reader to a location associated with the transaction.
